(19) United States
(12) Patent Application Publication
(10) Pub. No.: US 2025/0146590 A1
(43) Pub. Date: May 8, 2025

(54) INTEGRATED AIR VALVE STRUCTURE

(71) Applicant: TangTring Seating Technology Inc., Huizhou Guangdong (CN)

(72) Inventors: Tsun-Hsiang WEN, Taipei (TW); Chia-Yu YU, Taipei (TW); Peng ZHAO, Huizhou Guangdong (CN); Yung-Cheng LIU, Taipei (TW); Chao-Wen HUANG, Taipei (TW)

(21) Appl. No.: 18/503,299

(22) Filed: Nov. 7, 2023

(51) Int. Cl. F16K 24/00

(52) U.S. Cl. CPC F16K 24/00

(57) ABSTRACT

An integrated air valve structure includes a main body and two air valves. The main body is formed with two air passages not communicated with each other, a plurality of through holes disposed corresponding to the two air passages, and two valve mounting seats. One valve mounting seat is disposed corresponding to one of the through holes, the other valve mounting seat is disposed corresponding to two of the through holes belonging to the two air passages. The two air valves are disposed on the two valve mounting seats, each air valves includes an air plug facing at least one of the through holes, a valve body assembled with one of the two valve mounting seats for the air plug to move therein, and a coil disposed on the valve body for generating magnetic force to change a position of the air plug.

### FIELD OF THE INVENTION

The invention relates to an integrated air valve structure, and more particularly to an integrated air valve structure capable of achieving air intake, exhaust or holding on a single ventilation path.

### BACKGROUND OF THE INVENTION

CN100543360C discloses an air bag inflation and deflation system and an air valve assembly used by the system. The air valve assembly uses a plurality of air valves to control inflation and deflation, but the air valve assembly only uses a single air passage (that is, the main air passage in CN100543360C); as a result, when the air valves are in a switching state, air pressure in the air passage may produce erroneous flow. Further, when one of the air valves used for exhausting air is activated, the gas in the air passage, in addition to being discharged through one of the air valves, the gas also flows back toward a gas supply source through the same air passage.

### SUMMARY OF THE INVENTION

A main object of the invention is to solve the problem of backflow of exhaust gas in the conventional air valve structure.

A secondary object of the invention is to solve the problems caused by complexity of the conventional air valve structure.

In order to achieve the above objects, the invention provides an integrated air valve structure including a main body and two air valves. The main body is formed with two air passages not communicated with each other, a plurality of through holes respectively disposed corresponding to the two air passages, and two valve mounting seats. One of the two valve mounting seats is disposed corresponding to one of the through holes, the other one of the two valve mounting seats is disposed corresponding to two of the through holes respectively belonging to the two air passages. The two air valves are disposed on the two valve mounting seats, each of the two air valves has an air plug facing at least one of the through holes, a valve body assembled with one of the two valve mounting seats and being configured for the air plug to move therein, and a coil disposed on the valve body for generating magnetic force to change a position of the air plug based on energization condition. One of the two air valves is configure to determine communication of the two air passages to achieve air intake, the other of the two air valves is configured to determine whether one of the two air passages communicates externally to achieve exhaust, and the two air valves are configured to jointly determine whether the integrated air valve structure holds air pressure.

In one embodiment, the air plug of one of the two air valves used for exhausting has an exhaust passage, and the valve body has an exhaust hole communicated with the exhaust passage.

In one embodiment, one of the two valve mounting seats disposed corresponding to one of the two air valves for exhausting has an exhaust hole.

In one embodiment, each of the two air valves has an elastic member for restoring the air plug.

In one embodiment, each of the two air valves has an airtight ring disposed on the valve body and contacting one of the two valve mounting seats.

In one embodiment, the air plug has a plug body acted upon by the coil, and a plug cover disposed on the plug body and facing at least one of the through holes.

In one embodiment, the main body is formed with at least one auxiliary airtight ring disposed corresponding to one of the through holes.

In one embodiment, the main body is formed with a partition wall that separates the two air passages.

Through the foregoing implementation of the invention, compared with the prior art, the invention has the following characteristics: the two air passages formed on the main body of the invention are not directly communicated, thereby preventing gas from flowing back to a gas supply source during exhaust. In addition, installation structures of the two air valves of the invention are capable of shortening installation time and reducing difficulty of subsequent maintenance operations.

### BRIEF DESCRIPTION OF THE DRAWINGS

FIG. 1 is a perspective view of implementation of an embodiment of the invention.

FIG. 2 is a schematic structural diagram of an integrated air valve structure of the invention in a holding state.

FIG. 3 is a schematic structural diagram of the integrated air valve structure of the invention in an air intake state.

FIG. 4 is a schematic structural diagram of the integrated air valve structure of the invention in an exhaust state.

FIG. 5 is a schematic structural diagram of another embodiment of the integrated air valve structure of the invention.

### DETAILED DESCRIPTION OF THE PREFERRED EMBODIMENTS

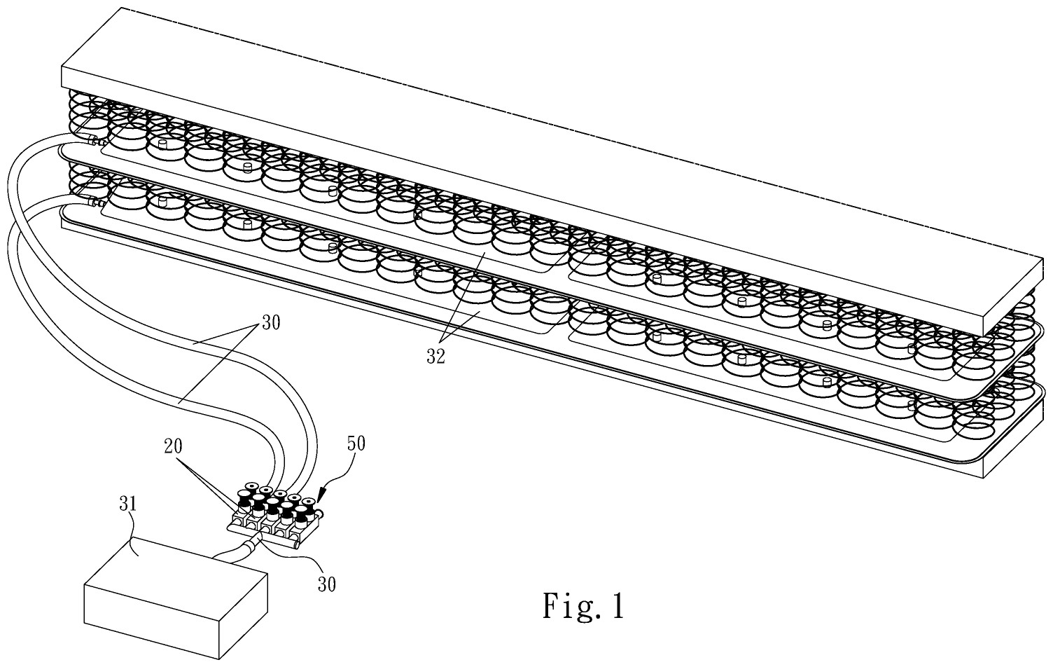

The detailed description and technical content of the invention are described below with reference to the accompanying drawings. Please refer to FIGS. 1, 2, 3, and 4. The invention provides an integrated air valve structure 20 including a main body 21 and two air valves 22. The main body 21 is formed with two air passages 211, a plurality of through holes 212, and two valve mounting seats 213.

The two air passages 211 can be connected to an air conduit 30 respectively. Although the two air passages 211 are formed in the main body 21 at the same time, the two air passages 211 are not communicated with each other. In addition, the through holes 212 are respectively provided corresponding to the two air passages 211. Further, each of the through holes 212 is provided corresponding to only one of the two air passages 211. In addition, the two valve mounting seats 213 respectively include a space 214 for disposing the two air valves 22. One of the two valve mounting seats 213 is disposed corresponding to one of the through holes 212. The other of the two valve mounting seats 213 is disposed corresponding to at least two of the through holes 212, and the at least two of the through holes 212 respectively correspond to the two air passages 211. When the at least two of the through holes 212 are not blocked, the two air passages 211 are capable of communicating with the space 214 formed by the corresponding one of the two valve mounting seats 213 through the at least two of the through holes 212.

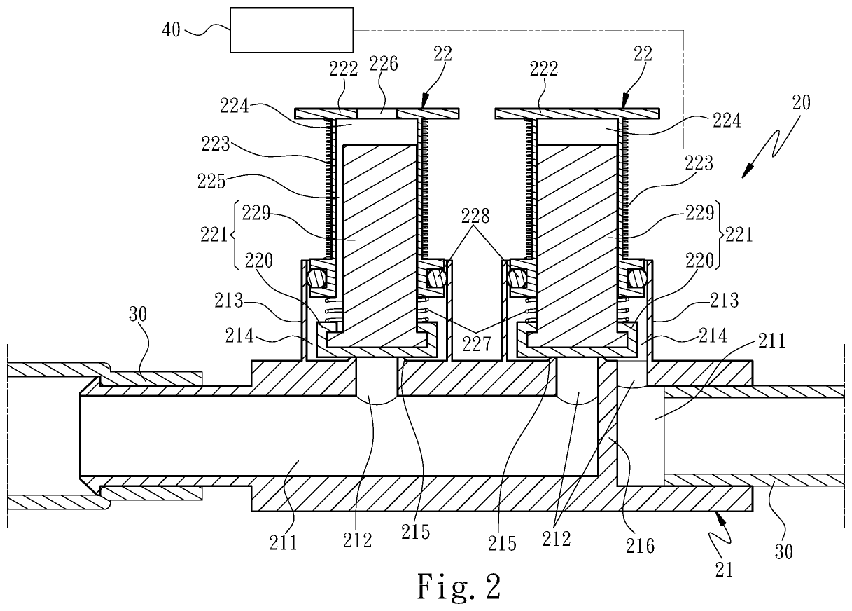

Please refer to FIGS. 2, 3, and 4 again. The two air valves 22 are disposed on the two valve mounting seats 213. Each of the two air valves 22 includes an air plug 221, a valve body 222, and a coil 223. The air plug 221 faces at least one of the through holes 212 located in one of the two valve mounting seats 213. The air plug 221 is movable relative to the valve body 222. The air plug 221 can be controlled to change its position in the space 214. More specifically, in principle, the air plug 221 includes a first position for blocking at least one of the through holes 212, and a second position for releasing at least one of the through holes 212. The valve body 222 is assembled with one of the two valve mounting seats 213. The valve body 222 is formed with an accommodating space 224 for placement and movement of the air plug 221. On the other hand, the coil 223 is disposed on the valve body 222, and the coil 223 is connected to an external power supply device 40 to obtain electric power required for operation. The coil 223 generates magnetic force based on an energization state to change a position of the air plug 221. It can be known from the above that the two air valves 22 of the invention are implemented with solenoid valve structures to achieve precise control and quick response. Furthermore, each of the two air valves 22 works independently, that is, actions of the two air valves 22 are not interlocked.

The integrated air valve structure 20 of the invention is capable of achieving air intake, exhaust or holding on a single ventilation path. That is to say, the integrated air valve structure 20 is one of the components constituting the aforementioned ventilation path, and a state of the integrated air valve structure 20 will change conditions in the aforementioned ventilation path. Further, one of the two air valves 22 of the invention determines communication of the two air passages 211 to achieve air intake, and the other of the two air valves 22 determines whether one of the two air passages 211 is communicated with external to achieve exhaust, and the two air valves 22 jointly determine whether the integrated air valve structure 20 holds air pressure.

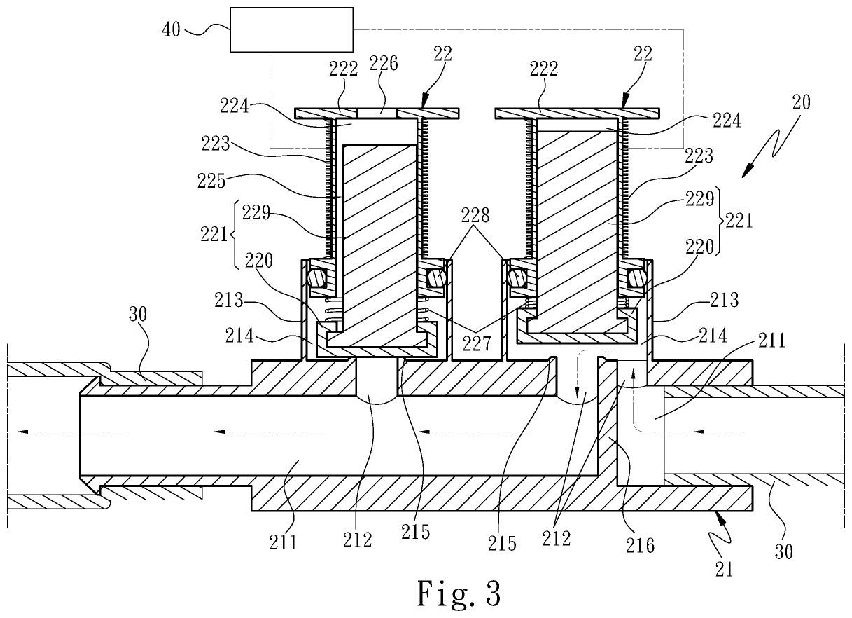

At an initial stage of implementation of the integrated air valve structure 20, one of the two air passages 211 can be connected to a gas supply source 31 (such as a pump) through the air conduit 30, and the other of the two air passages 211 can be connected to an inflatable element 32 (such as an air bag) through the other air conduit 30. Assume that the two air valves 22 on the integrated air valve structure 20 are inactive in a current state, the air plug 221 of each of the two air valves 22 is located at the first position, as shown in FIG. 2. Please refer to FIG. 3 again. When the inflatable element 32 is to be inflated, the coil 223 in one of the two air valves 22 corresponding to at least two of the through holes 212 is energized to generate magnetic force, causing the air plug 221 of the aforementioned one of the two air valves 22 to displace from the first position to the second position. The two air passages 211 communicate with the space 214 in one of the two valve mounting seats 213 through at least two of the through holes 212, thereby gas provided by the gas supply source 31 is capable of flowing in the two air passages 211 sequentially to inflate the inflatable element 32.

Please refer to FIG. 2 again. When air pressure in the inflatable element 32 is to be held, the air plugs 221 of the two air valves 22 on the integrated air valve structure 20 will be controlled to be in the first position in order to achieve air pressure holding.

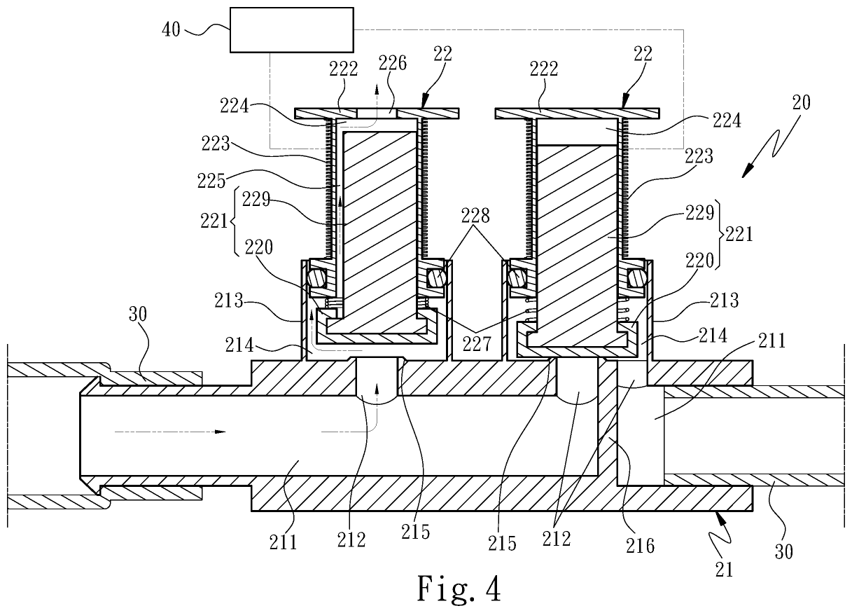

Please refer to FIG. 4 again. When air pressure in the inflatable element 32 is to be reduced, e.g., deflating the inflatable element 32, the coil 223 in one of the two air valves 22 corresponding to at least one of the through holes 212 is energized, the air plug 221 of one of the two air valves 22 is displaced from the first position to the second position, and one of the two air passages 211 is communicated with the external through at least one of the released through holes 212 to achieve exhaust.

In the invention, the two air passages 211 formed on the main body 21 are not directly communicated. There is a partition wall 216 directly formed by the main body 21 between the two air passages 211. The partition wall 216 separates the two air passages 211, so that the two air passages 211 are not directly communicated. The partition wall 216 and one of the two air valves 22 are capable of preventing gas from flowing back to the gas supply source 31 during exhaust. Further, the gas supply source 31 and the inflatable element 32 can be disposed at a same level, thereby reducing space requirements. Installation structures of the two air valves 22 of the invention are capable of shortening installation time and reducing difficulty of subsequent maintenance operations.

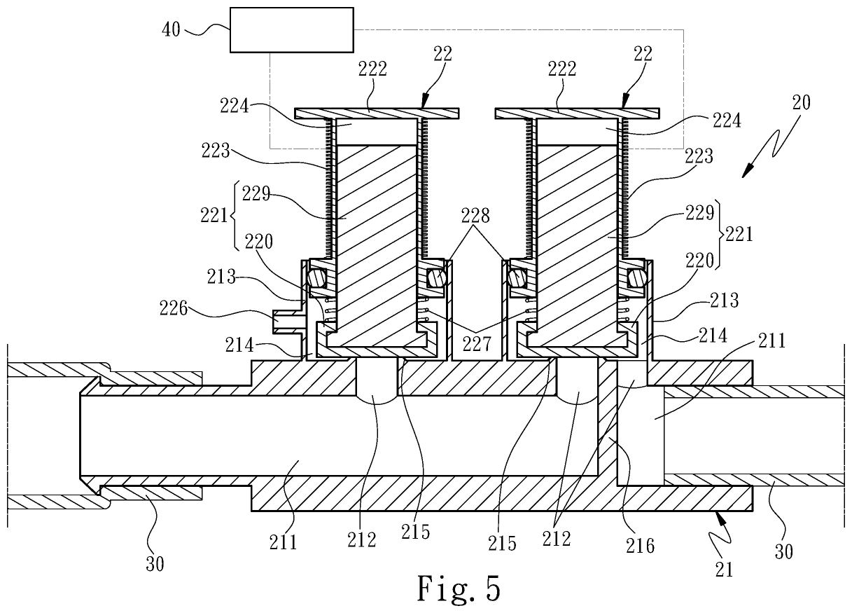

Please refer to FIG. 2 and FIG. 3 again. The air plug 221 of one of the two air valves 22 for exhausting has an exhaust passage 225, and the valve body 222 of one of the two air valves 22 has an exhaust hole 226 communicated with the exhaust passage 225. In addition, one end of the exhaust passage 225 is communicated to the space 214 formed by one of the two valve mounting seats 213, and another end of the exhaust passage 225 is communicated to the exhaust hole 226. Further, in principle, the exhaust passage 225 does not affect air blocking of at least one of the through holes 212 by the air plug 221. Please refer to FIG. 5. In addition to the above, in another embodiment, the air plug 221 does not have the exhaust passage 225, and the exhaust hole 226 originally formed on the valve body 222 is instead formed on the two valve mounting seats 213. In this way, once the air plug 221 is changed from the first position to the second position, at least one of the through holes 212 that is released communicates with the exhaust hole 226 through the space 214 in one of the two valve mounting seats 213 to realize exhaust.

Please refer to FIGS. 2, 3, and 4 again. In one embodiment, each of the two air valves 22 includes an elastic member 227 for restoring the air plug 221. The elastic member 227 can be a spring or the like capable of storing rebound force. Two ends of the elastic member 227 respectively abut against the air plug 221 and the valve body 222. The elastic member 227 pushes against the air plug 221 to displace toward a direction of at least one of the through holes 212 when the air plug 221 is not acted by magnetic force generated by the energized coil 223.

Please refer to FIGS. 2, 3, and 4 again. In one embodiment, each of the two air valves 22 includes an airtight ring 228. The airtight ring 228 is disposed on the valve body 222 and contacts one of the two valve mounting seats in order to prevent the occurrence of erroneous deflation.

Please refer to FIGS. 2, 3, and 4 again. In one embodiment, the air plug 221 includes a plug body 229 and a plug cover 220. Part of the plug body 229 is accommodated in the valve body 222, and the plug body 229 can be acted upon by the coil 223. In addition, the plug cover 220 can be made of a soft rubber material. The plug cover 220 is disposed on the plug body 229 and faces at least one of the through holes 212.

Please refer to FIGS. 2, 3, and 4 again. In one embodiment, the main body 21 is formed with at least one auxiliary airtight ring 215. The at least one auxiliary airtight ring 215 is provided corresponding to one of the through holes 212. The at least one auxiliary airtight ring 215 is actually an annular rib forming a periphery of one of the through holes 212. When the air plug 221 is in the first position, the air plug 221 is capable of contacting the at least one auxiliary airtight ring 215 to increase air sealing effect.

An air valve device 50 can be formed by a plurality of the integrated air valve structures 20 of the invention, as shown in FIG. 1.

What is claimed is:

1. An integrated air valve structure, comprising:
a main body, formed with two air passages, a plurality of through holes, and two valve mounting seats, the two air passages not communicated with each other, the plurality of through holes respectively disposed corresponding to the two air passages, one of the two valve mounting seats being disposed corresponding to one of the plurality of through holes, the other one of the two valve mounting seats disposed corresponding to two of the plurality of through holes respectively belonging to the two air passages; and
two air valves, disposed on the two valve mounting seats, each of the two air valves comprising an air plug facing at least one of the plurality of through holes, a valve body assembled with one of the two valve mounting seats and being configured for the air plug to move therein, and a coil disposed on the valve body for generating magnetic force to change a position of the air plug based on energization condition;
wherein one of the two air valves is configured to determine communication between the two air passages to achieve air intake, the other of the two air valves is configured to determine whether one of the two air passages communicates with external to achieve exhaust, and the two air valves are configured to jointly determine whether the integrated air valve structure holds air pressure.

2. The integrated air valve structure as claimed in claim 1, wherein in one of the two air valves used for exhausting, the air plug comprises an exhaust passage, and the valve body comprises an exhaust hole communicated with the exhaust passage.

3. The integrated air valve structure as claimed in claim 1, wherein one of the two valve mounting seats disposed corresponding to one of the two air valves for exhausting comprises an exhaust hole.

4. The integrated air valve structure as claimed in claim 1, wherein each of the two air valves comprises an elastic member for restoring the air plug.

5. The integrated air valve structure as claimed in claim 1, wherein each of the two air valves comprises an airtight ring disposed on the valve body and contacting one of the two valve mounting seats.

6. The integrated air valve structure as claimed in claim 1, wherein the air plug comprises a plug body acted by the coil, and a plug cover disposed on the plug body and facing at least one of the through holes.

7. The integrated air valve structure as claimed in claim 6, wherein the main body is formed with a partition wall that separates the two air passages.

8. The integrated air valve structure as claimed in claim 1, wherein the main body is formed with at least one auxiliary airtight ring disposed corresponding to one of the through holes.

9. The integrated air valve structure as claimed in claim 1, wherein the main body is formed with a partition wall that separates the two air passages.
